(19) United States
(12) Patent Application Publication
(10) Pub. No.: US 2013/0137069 A1
(43) Pub. Date: May 30, 2013

(54) CARD GAME

(71) Applicant: James Brian Olson, White Rock (CA)

(72) Inventor: James Brian Olson, White Rock (CA)

(21) Appl. No.: 13/307,798

(22) Filed: Nov. 30, 2011

(51) Int. Cl. G09B 19/22

(52) U.S. Cl. 434/129

(57) ABSTRACT

A card and deck of cards for teaching information to a user each comprising a substantially planar body having first and second sides. A question portion is provided on the first side and an answer portion is provided on the second side. At least one value region having an indication representing a standard playing card value is also provided on the second side.

### BACKGROUND OF THE INVENTION

1. Field of Invention

The present invention relates to cards in general and in particular to an apparatus for teaching through a card game.

2. Description of Related Art

It is commonly known that games are a useful means to teach people new information in a way which is interesting and fun to them. Such teaching methods present the information which is to be taught to the student in a manner which is interesting for them and therefore more prone to be remembered.

In many fields of endeavor, new information is particularly difficult to learn due to the new structure of information in that field as well as new terminology to learn. Many previous attempts have been made to provide a trivia games which provide some of the function of learning. Such games however have not included a sufficient and predictable increase of difficulty level as the student learns the subject area.

Such games have also required at least two players so as to permit one player to ask a question of the other player. Examples of such games may be found in US Patent Application Publication No. 2008/0203668 to Laisney published Aug. 28, 2008. Disadvantageously, such a game has less use for a player to play alone as the player is required to read their own question and the answer is located on the same side as the question thereby not requiring the player to attempt to answer the question on their own.

Other trivia-style games have been less focused on a single topic, and more on general interest questions on a wide variety of fields. Such games have had a limited ability to teach a person a particular area of interest due to the broad and general nature of the questions. Some people may also be prone to lose interest in such a game due to the number of questions related to fields not of interest to the player.

Books and other traditional teaching may also be of less use to many users. This may be particularly the case for users who have a reduced attention span and may therefore find a book to be too time consuming to read to a sufficient amount to properly learn the topic. Some users may also find books to be intimidating. Additionally, some books are quite expensive and large to buy and store for many people.

### SUMMARY OF THE INVENTION

According to a first embodiment of the present invention there is disclosed a card for teaching information to a user comprising a substantially planar body having first and second sides. A question portion is provided on the first side and an answer portion is provided on the second side. At least one value region having an indication representing a standard playing card value is also provided on the second side.

The second side may further include at least one point region having an indication representing a point value. The answer portion may further include a reference portion providing a source of reference for the answer to the question. The answer portion may further include an information field displaying information related to the answer portion. The second side may further include an advertising portion.

According to a further embodiment of the present invention there is disclosed a deck of cards comprising a plurality of cards for teaching information to a user each comprising a substantially planar body having first and second sides. A question portion is provided on the first side and an answer portion is provided on the second side. At least one value region having an indication representing a standard playing card value is also provided on the second side. Each of the plurality of cards includes a unique playing card value.

The second side of each card may further include at least one point region having an indication representing a point value. Each of the point values may be determined by a base value multiplied by a suit multiplier. Each of the plurality of playing card suits may have a unique suit multiplier wherein each of the point values is multiplied by the suit multiplier corresponding to the suit of each card. Each numbered card of each suit may have the same base value. Each face card may have a unique base value.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a top plan view of the front surface of a card according to a first embodiment of the present invention.

FIG. 2 is a top plan view of the rear surface of the card of FIG. 1.

### DETAILED DESCRIPTION

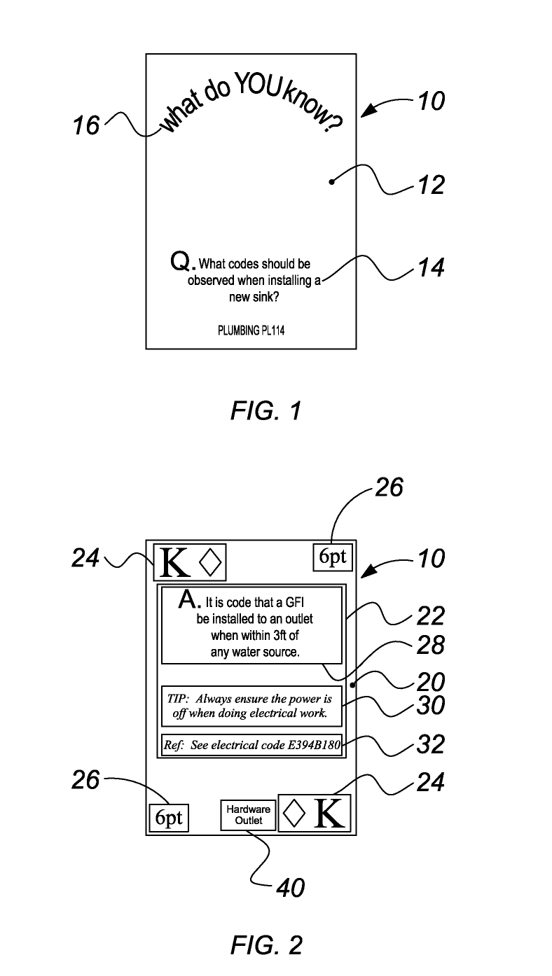

Referring to FIGS. 1 and 2, a card according to a first embodiment of the invention is shown generally at 10. The card comprises a substantially planar body having front and rear surfaces 12 and 20. As illustrated the card may be of a size and shape corresponding to a conventional playing card although it will be appreciated that other dimensions for the cards may be utilized as well.

With reference to FIG. 1, the front surface 12 of the card 10 includes a question portion 14 and an optional logo portion 16. The question portion includes a question for the user to either answer themselves or ask of another person as will be described more fully below.

With reference to FIG. 2, the rear surface 20 of the card 10 includes an answer portion 22, at least one value region 24, and at least one point region 26. The answer portion 22 includes an answer 28 to the question posed in the question portion 14 on the front surface 12 of the card 10. The answer portion may further optionally include additional relevant information, generally indicated at 30 and a reference for the answer 32. The reference may comprise information relating to the source of the answer, such a as a building code, legal stature or other rule by way of non-limiting example. Optionally, each card may also include an advertising portion 40

The value regions 24 may be located in the two opposed corners of the card 10 as is common with a standard deck of playing cards. The value regions 24 represent a playing car value, such as, by way of example a standard playing card value from Ace to King in four suits (diamonds, spades, hearts and clubs). It will be appreciated that other playing card values may also be utilized. It will also be appreciated that the cards 10 of the present invention may be provided in a pack of cards selected to form a standard pack of playing cards.

Each point region 26 comprises a number representing a point value for that card. The point value for each card may be selected to be different from each other or may optionally be the same for each card within a subset of the overall deck. By way of non-limiting example, according to the table 1:

TABLE 1
Point System

| Cards | Diamonds | Clubs | Hearts | Spades |
|---|---|---|---|---|
| Ace | 1 | 2 | 3 | 4 |
| 1 | 1 | 2 | 3 | 4 |
| 2 | 1 | 2 | 3 | 4 |
| 3 | 1 | 2 | 3 | 4 |
| 4 | 1 | 2 | 3 | 4 |
| 5 | 1 | 2 | 3 | 4 |
| 6 | 1 | 2 | 3 | 4 |
| 7 | 1 | 2 | 3 | 4 |
| 8 | 1 | 2 | 3 | 4 |
| 9 | 1 | 2 | 3 | 4 |
| 10 | 1 | 2 | 3 | 4 |
| Jack | 2 | 3 | 4 | 5 |
| Queen | 4 | 5 | 6 | 7 |
| King | 6 | 7 | 8 | 9 |
| Joker | Free Switch | | | |
| Totals | 22 | 25 | 48 | 61 |

| | |
|---|---|
| Total Points Available: | 166 Pts |

As set out above, each numbered card from 1 (or Ace) to 10 may have a common point value. The suits of the deck of cards may be differentiated from each other by a suit multiplier. With reference to Table 1 by way of non-limiting example, each numbered card may have a base value of 1 wherein diamonds have a suit multiplier of 1, clubs have a suit multiplier of 2, hearts have a suit multiplier of 3 and spades have a suit multiplier of 4. Accordingly each number of each given suit will have a different point value. With reference to Table 1 above, the each face card (jack, queen or king) may also have a bonus point value so as to increase the point value of these cards above the point value of the remainder of that suit. By way of non-limiting example, the jack may have a bonus point value of 1 point so as to be one point higher than the remainder of that suit. Similarly, the queen may have a bonus point value of 3 and the king a bonus point value of 5. Utilizing differing point values for each number or suit permits the deck of cards to have varying difficulty levels so as to challenge players of differing knowledge levels. In some embodiments, the joker may be utilized as a “switch” card whereby if a player draws the joker, they may hold it for a later game and the player is asked the question on the next card in the pile. When that player is later asked a question they do not know the answer to, they may use the joker to pass on that question and draw another card whereby the question that is passed on is placed in the incorrectly answered pile. The joker is also placed in the incorrectly answered pile for use in a later round.

The questions 14 and answers 28 provided on each card will correspond to a particular subject matter, such as by way of non-limiting example, plumbing, electrical building codes, automotive repair, computers or any other subject matter. Achieving a predetermined score in a particular subject matter earns that user the distinction of being a “graduate student”. By way of non-limiting example, the predetermined score may be a perfect score of 166 points in deck of Table 1 as set out above although other scores may be utilized as well. Users may attempt to achieve this distinction in more than one subject area as desired. Optionally, a personalized deck of cards may be provided with blank writable areas for the question and answer. In such a deck of cards, the user may create their own questions and answers, such as, by way of non-limiting example, relating to themselves to test others as to how well they know that person. It will be appreciated that the questions 14 and their corresponding answers 28 may be related to virtually any subject matter in life including the whos, whats, whens, wheres, whys and hows of life and may therefore comprise a modular encyclopedia which is expandable according to the users interests. It will also be appreciated that the cards of the present description may also be useful as a commercial training tool to train employees customers or anyone else about a particular subject area or safety rules.

In operation, a user may begin with the cards in a stack with the question or front side facing up. The user may then attempt to answer the question 14 on that card and may thereafter check their answer by turning over the card to view the answer 28 on the back side of the card 10 see if they were correct. In such a manner, the user may work their way through the deck of cards, doing their best to answer each question correctly. The cards may be arranged in their stack in order of increasing difficulty, such as, by way of non-limiting example, in order starting at the ace of diamonds to the king of diamonds, and with the clubs, hearts and spades following in order. Incorrectly answered cards are placed in a separate incorrectly answered card pile to be played through again at the end of that round until all questions have been answered correctly. At that time, points are totaled and the game is over. Each card which is answered correctly may be placed in a correct answer pile to the side to be added later. After the user has correctly answered or attempted to answer each card, they may add up the point values shown on each card. The user may utilize this score to challenge themselves to attempt to more fully learn the subject area and thereby improve their score. The user may also challenge other people to equal or beat their score. Optionally, the user may post their score to a website such as a social media website such as Facebook® or Twitter®.

In another embodiment, the user may play a game with one or more other people by shuffling the deck of cards and placing them in a pile Each player may successively draw the top card from the pile and reading the question out loud to the other player. If the question is answered correctly, the player to answer correctly receives the points associated with that card and the card is placed in a correctly answered pile. Conversely, incorrectly answered cards are placed in an incorrectly answered card pile to be repeated as set out above.

In a further embodiment, a website may be provided having lists of scores which are achieved for each deck of cards. Users may therefore challenge each other and rank themselves with other persons.

While specific embodiments of the invention have been described and illustrated, such embodiments should be considered illustrative of the invention only and not as limiting the invention as construed in accordance with the accompanying claims.

What is claimed is:

1. A card for teaching information to a user comprising a substantially planar body having first and second sides, a question portion on said first side, an answer portion on said second side and at least one value region having an indication representing a standard playing card value on said second side.

2. The card of claim 1 wherein said second side further includes at least one point region having an indication representing a point value.

3. The card of claim 1 wherein said answer portion further includes a reference portion providing a source of reference for said answer to said question.

4. The card of claim 1 wherein said answer portion further includes an information field displaying information related to said answer portion.

5. The card of claim 1 wherein said second side further includes an advertising portion.

6. A deck of cards comprising a plurality of the cards of claim 1 wherein each of said plurality of cards includes a unique playing card value.

7. The deck of cards of claim 6 wherein said second side of each card further includes at least one point region having an indication representing a point value.

8. The deck of cards of claim 7 wherein each of said point values is determined by a base value multiplied by a suit multiplier.

9. The deck of cards of claim 8 wherein each of said plurality of playing card suits has a unique suit multiplier wherein each of said point values is multiplied by said suit multiplier corresponding to the suit of each card.

10. The deck of cards of claim 7 wherein each numbered card of each suit has the same base value.

11. The deck of cards of claim 7 wherein each face card also has a unique bonus value.
